(19) United States
(12) Patent Application Publication
(10) Pub. No.: US 2005/0199357 A1
(43) Pub. Date: Sep. 15, 2005

(54) Shade with thermochromic temperature sensor

(76) Inventor: Steven B. Dunn, Beverly Hills, CA (US)

Correspondence Address: KNOBLE YOSHIDA & DUNLEAVY, LLC;Eight Penn Center, Suite 1350, 1628 John F. Kennedy Blvd., Philadelphia, PA, 19103, US

(21) Appl. No.: 10/797,642

(22) Filed: Mar. 10, 2004

(51) Int. Cl. E06B 9/08

(52) U.S. Cl. 160/370.22

(57) ABSTRACT

A sunshade for a vehicle, such as a car, that includes a housing to contain the shade. There is a first attachment member located on the housing for attaching the housing to a window. There is shade element attached to an interior of the housing and enabled to be moved from a retracted first position inside, wherein the shade element is at least partially within the housing to an extended second position wherein the shade element is at least partially outside of the housing. The window shade also has a handle member attached to the shade element. This handle member can have on it a gripping element so that someone can easily grab the shade element and pull it down. There is a second attachment member located on the handle for attaching the handle to the window. In a preferred embodiment the first and second attachment members are suction cups. There is also a temperature sensor, preferably made of thermochromic material, positioned so that it is thermally insulated from the window. This permits the temperature sensor to provide an accurate indication of the temperature of the interior of the vehicle.

### BACKGROUND OF THE INVENTION

1. Field of Invention

This invention relates generally to the field of automotive accessories, and more specifically to vehicle sunshades that are attachable to a window of a vehicle for protecting occupants and cargo that are in the vehicle from direct exposure to sunlight. In particular it relates to the provision of a temperature sensor on the window shade.

2. Description of Related Technology

Window shades are currently sold for windows to reduce the risk of sunburns and to lower the ambient temperature of the windowed compartment. Shades are most commonly used in automobiles and for the protection children sitting inside the automobile. These window shades, or sunshades, come in two common types: plastic sheets that are placed directly against the window, static cling style shades, and versions that are attached using suction cups. The suction cup shades are commonly fastened to a frame on the top and bottommost portions of the shade. Many of these suction cup styles have the capability to retract into the topmost frame allowing a caregiver to easily move the shade out of the way when they are not transporting a child or there is no need to shade the child.

Current products that include a temperature-sensing element are of the “static cling” style. Temperature sensors on “static cling” style shades sense the temperature of the window instead of the internal compartment. This does not give an accurate temperature reading to the caregiver. Contact with the window or direct sunlight will often raise the temperature of the sensor to create a reading that does not reflect the interior's temperature. This repeated creation of a false reading undermines the purpose of having the sensor. A caregiver will begin to ignore the sensor after repeated false readings.

Temperatures rise very quickly within an enclosed car. Children and pets die every year of heat exhaustion from being left inside cars. The inability of window shade technology to accurately inform someone of interior car temperatures creates an unneeded risk.

Therefore the need exists for a temperature sensor on a window shade that does not produce inaccurate results. This invention solves the problem of providing inaccurate results and provides a clear indication of the internal temperature of a car.

### SUMMARY OF THE INVENTION

Accordingly it is an object of the invention to provide a temperature sensor on a window shade that does not produce inaccurate results.

In order to achieve the above and other objects of the invention, a window shade for a vehicle according to a first aspect of the invention includes a housing; a first attachment member located on the housing for attaching the housing to a window; a shade element attached to an interior of the housing and enabled to be moved from a retracted first position inside, wherein the shade element is at least partially within the housing to an extended second position wherein the shade element is at least partially outside of the housing; a handle member attached to the shade element; a second attachment member located on the handle for attaching the handle to the window; and a temperature sensor positioned to be thermally insulated from the window.

A window shade according to a second aspect of the invention includes housing structure for housing a shade element; a first attachment structure located on the housing for attaching the housing structure to a window; retracting structure for retracting a shade element attached to an interior of the housing; extending structure for extending a shade element to an exterior of the housing; a second attachment structure located on a handle for attaching the handle to the window; and a temperature sensing structure positioned to be thermally insulated from structure window for sensing the temperature.

According to a third aspect of the invention, a window shade for a vehicle includes a shade member; mounting structure for mounting the shade member to a vehicle window; and a temperature sensor that is mounted so as to be thermally insulated from said vehicle window.

These and other objects of the present invention will be apparent from the detailed descriptions of the invention, which follow.

### BRIEF DESCRIPTION OF THE DRAWINGS

FIG. 1 is a perspective view of a vehicle sun shade assembly that is constructed according to a preferred embodiment of the invention, shown in a first, retracted position.

FIG. 2 is a perspective view of the sunshade assembly shown in FIG. 1, depicting a different side of the assembly.

FIG. 3 is a perspective view of an alternative embodiment of the sunshade assembly shown in extended position with the temperature sensor on the shade.

FIG. 4 is a perspective view of an alternative embodiment of the vehicle sunshade assembly that is constructed with a display device.

FIG. 5 is a perspective view of an alternative embodiment of the sunshade assembly that is constructed with an alarm device.

### DETAILED DESCRIPTION OF THE PREFERRED EMBODIMENT(S)

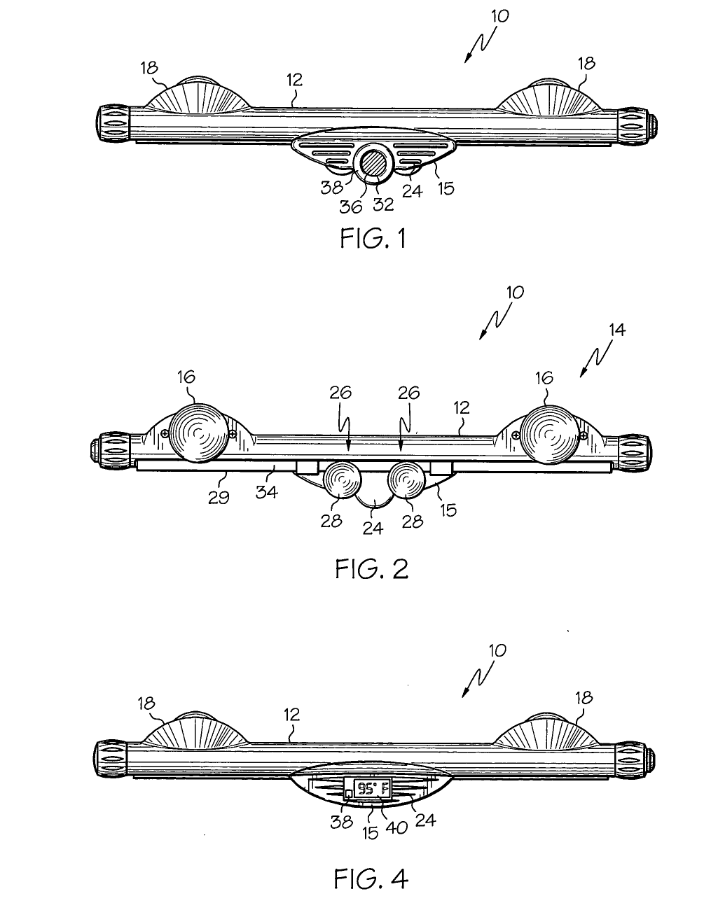

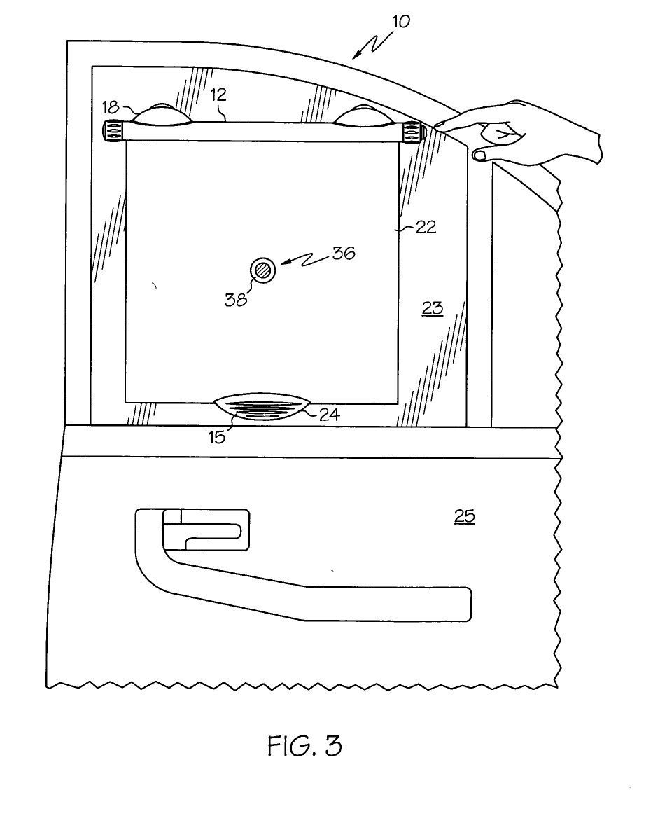

Referring now to the drawings, wherein like reference numerals designate corresponding structure throughout the views, and referring in particular to FIG. 1, a sunshade 10 that is constructed according to a preferred embodiment of the invention includes a housing 12 that is preferably shaped and sized so as to preclude a person from being able to touch a portion of a shade element 22 that is wrapped about an interior drum member whereby the possibility of the person's fingers being pinched is reduced. As may best be seen in FIGS. 2 and 3, housing 12 is provided with first mounting structure 14 for mounting the housing 12 and thereby the sunshade 10 to a first portion of a window 23 on a vehicle door 25 that is part of a vehicle such as an automobile. In the preferred embodiment, first mounting structure 14 has a pair of suction cups 16 that act as the attachment members. The suction cups 16 are shaped and sized to adhere to the first portion of the vehicle window 23 with a force that is sufficient to support the weight of the sun shade 10 and, in addition, to resist any forces and accelerations that would be expected during mounting, adjustment and use. Suction cups 16 are preferably mounted symmetrically to each other along a longitudinal axis of the housing 12. The suction cups 16 also assist in raising the window shade off of the window 23 so as to thermally insulate the temperature sensor 38. As may be seen in FIG. 1, housing 12 includes for aesthetic and safety purposes a pair of rounded projections 18 that extend upwardly from the longitudinal axis of the housing 12 in order to obscure access to and view of the suction cups 16 when the sunshade 10 is mounted to a vehicle window. In addition to the aesthetic benefit that is provided by the rounded projections 18, their presence makes it harder for little fingers to access the periphery of the suction cups 16 during use, which could break the vacuum seal of one or more of the suction cups 16 and cause the sun shade 10 to swing out of position or to fall.

A drum member is rotatably mounted with respect to the housing 12 and, as may best be seen in FIG. 3, a flexible, web-like shade element 22 is wrapped about the drum member. A distal end of the flexible, web-like shade element 22 is attached to a handle 15, which in the preferred embodiment is molded from a polymeric material such as polyvinyl chloride (PVC), polypropylene or polyethylene and which has second mounting structure 26 provided thereon for mounting the handle 15 to a second portion of the vehicle window 23. Any of these materials, and for that matter any plastic material, would be considered a good thermal insulation material for purposes of the invention, while a metallic material would not be considered to be a good insulation material. Preferably, the material used in constructing the handle is durable and does not conduct heat rapidly, as would a metallic material, so as further thermally insulate the temperature sensor 28.

As shown in FIG. 1, in a preferred embodiment a temperature sensor 38 is located on the opposite side of the handle 15 from the suction cups 28. The handle 15 is preferably at least one millimeter thick at the location of the temperature sensor 38, thereby providing at least one millimeter of good thermal insulation material between the car window and the temperature sensor. This permits a more accurate reading of the vehicle's interior temperature by shielding the temperature sensor 38 from direct sunlight when the sunshade 10 is mounted on the window 23. In a preferred embodiment, the temperature sensor 38 is made of a thermochromic material 36. Thermochromic materials rapidly and reversibly change color in the presence of heat. The change in color happens at a determined temperature, which can be varied through doping of the material. In the preferred embodiment the thermochromic material is located in a recess 32. The recess 32 provides further thermal insulation for the thermochromic material as well as helps to protect the material from dirt and debris and impact damage. Typically there are indicia, or markings, 30 near the temperature sensor 39 in order to explain its functionality.

According to one aspect of the invention, the second mounting structure 26 and a handle 15 are together shaped, sized and constructed in such a manner so as to permit a consumer to disengage the second mounting structure 26 from the vehicle window 23 by manipulating the handle 15. Additionally, the second mounting structure 26 and the handle 15 are sized, shaped and constructed in such manner that the handle 15 will be engaged by the door 25 if it is attempted to lower the second portion of the vehicle window 23 downwardly into the door 25. This will result in a prying action that will disengage the second mounting structure 26 from the vehicle window 23, preventing damage to the sunshade 10 and the vehicle. The handle 15 further has gripping elements 24 to further help in securing a hold on the handle. In the preferred embodiment, the gripping elements are unitarily formed with the handle and are raised bars. Alternatively they could be made of some of other material, such as gripping tape, in order to provide more friction when grasping the handle 15.

In the embodiment that is depicted in FIGS. 2 and 3, it will be seen that the second mounting structure 26 is constructed as a pair of second attachment members, suction cups 28, which are preferably molded so as to be unitary with the handle 15. In this embodiment of the invention, it will be seen that the suction cups 28 are aligned with each other along an axis 29 that is generally parallel to the longitudinal axis of the housing 12, and that the handle 15 extends outwardly from the housing 12 so as to define a distance L₁ between the outermost grippable point of the handle 15 and the axis 29 along which the suction cups 28 are situated. This functionally creates a lever arm by which a consumer such as a parent or other caregiver can quickly and easily detach the suction cups 28 from the vehicle window by grasping the handle 15 and pulling the outer end of the handle 15 away from the vehicle window. Preferably, the distance L₁ is within a range of about 0.4 in. to about 2.5 in., and more preferably within a range of about 0.5 in. to about 1.5 in. Furthermore, each of the suction cups 28 are preferably constructed and arranged so as to have an effective force of adhesion to a glass surface that is within a range of about 0.1 lb. of force to about 3.5 lb. of force, and that is more preferably within a range of about 0.5 lb. of force to about 2.8 lb. of force.

The suction cups 28 also act to raise the handle 15 and the shade element 22 off of the surface of the window 23. This helps to thermally insulate the temperature sensor 38 and further permits the temperature sensor 38 to get a more accurate reading of the interior of the vehicle. In addition, as can be seen in FIG. 2, there is also a metal bar 34 that acts as heat sink to further permit the temperature sensor 38 to achieve an accurate reading of the interior of the vehicle. An additional benefit of the extended length of the handle 15 is that it obscures views of the suction cups 28 to those, such as small children, within the vehicle. As a result, a small child will be less likely to be tempted to manipulate the suction cups 28, which could result in a distraction to the driver of the vehicle. To some extent, it would also interfere with the physical possibility of a small child interfering with the suction cups 28.

As shown in FIG. 3, in this alternative embodiment the temperature sensor is located on the shade element 22. Because of the construction of the sunshade 10, the shade element 22 is spaced from the vehicle window 23 by a distance of at least one millimeter, providing at least one millimeter of good thermal insulation material, in this case air, between the vehicle window 23 and the temperature sensor. Due to the flexibility of thermochromic material 36 this is possible. It is further possible to have certain figures and shapes made of the thermochromic material 36 and act as the temperature sensor 38. This would have a further advantage of conveying to children the danger of the interior temperature of the vehicle through the usage of appropriate warning shapes. Alternatively, the temperature sensor 38 may be located on the housing 12. Placing the temperature sensor 38 on the housing 12 has the added benefit of keeping the temperature sensor 38 out of the reach of children, and still retaining the benefits of being thermally insulated by being placed above the surface of the window 23.

FIG. 4 shows another alternative embodiment wherein the temperature sensor 38 has a display 40 disposed on the handle 15. This display may be either digital or analog. This display may be placed on the shade 22 or the housing 12. This would provide a numeric readout for an individual that would better provide them with more detailed information about the interior of the vehicle. Preferably, the portion of the temperature sensor 38 that actually detects temperature is spaced and a location that is thermally insulated from the vehicle window 23, preferably by at least one millimeter of thickness of good insulation material.

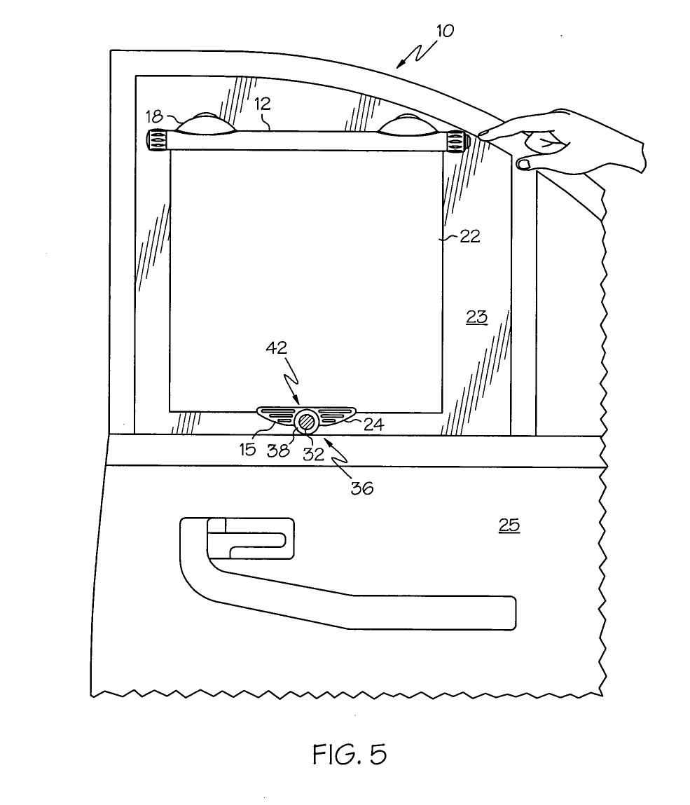

FIG. 5 shows another embodiment wherein there is an alarm device 42 provided for use with the temperature sensor 38. The alarm device 42 can produce either an audio alarm, such as a loud noise or verbal warning, or a visual alarm, such as flashing lights, etc. The alarm device 42 would provide additional warning to an individual of the dangerous temperatures to be found within the interior of the car.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A window shade for a vehicle comprising:
a housing;
a first attachment member located on said housing for attaching said housing to a window;
a shade element attached to an interior of said housing and enabled to be moved from a retracted first position inside, wherein said shade element is at least partially within said housing to an extended second position wherein said shade element is at least partially outside of said housing;
a handle member attached to said shade element;
a second attachment member located on said handle for attaching said handle to said window; and
a temperature sensor positioned on said window shade to be thermally insulated from said window.

2. A window shade for a vehicle according to claim 1, wherein said temperature sensor is made of a thermochromic material.

3. A window shade for a vehicle according to claim 1, wherein said temperature sensor is thermally insulated from said window by at least one millimeter of good insulation material.

4. A window shade for a vehicle according to claim 1, wherein said temperature sensor is located on said handle.

5. A window shade for a vehicle according to claim 1, wherein said temperature sensor is recessed within said handle.

6. A window shade for a vehicle according to claim 1, wherein said second attachment member is located on an opposite side of said handle from said temperature sensor.

7. A window shade for a vehicle according to claim 1, wherein said shade element has a metal bar located proximate to said handle to provide a heat sink in order to thermally insulate said temperature sensor.

8. A window shade for a vehicle according to claim 1, wherein said second attachment member comprises a suction cup.

9. A window shade for a vehicle according to claim 1, wherein said temperature sensor is located on said shade element or said housing.

10. A window shade for a vehicle according to claim 9, wherein said temperature sensor is located on an opposite side of said shade element or said housing then said second attachment member.

11. A window shade for a vehicle according to claim 1, wherein said temperature sensor has a temperature display.

12. (canceled)

13. A window shade comprising:
housing means for housing a shade element;
a first attachment means located on said housing for attaching said housing means to a window;
retracting means for retracting a shade element attached to an interior of said housing;
extending means for extending a shade element to an exterior of said housing;
a second attachment means located on a handle for attaching said handle to said window; and
a temperature sensing means positioned on said window shade to be thermally insulated from said window for sensing the temperature.

14. A window shade according to claim 13, wherein said temperature sensing means uses a thermochromic material.

15. A window shade according to claim 13, wherein said temperature sensing means is thermally insulated from said window by at least one millimeter of good thermal insulation material.

16. A window shade according to claim 13, wherein said temperature sensing means is located on said handle.

17. A window shade according to claim 16, wherein said temperature sensing means is recessed within said handle.

18. A window shade according to claim 16, wherein said second attachment means is located on an opposite side of said handle from said temperature sensing means.

19. A window shade according to claim 13, wherein said shade element has a metal bar located proximate to said handle to further thermally insulate said temperature sensor.

20. A window shade according to claim 13, wherein said second attachment means is a suction cup.

21. A window shade according to claim 13, wherein said temperature sensing means is located on said shade element or said housing.

22. A window shade according to claim 21, wherein said temperature sensor is located on an opposite side of said shade element or said housing then said second attachment member.

23. A window shade according to claim 13, wherein said temperature sensing means further comprises displaying means for displaying a temperature measurement.

24. (canceled)

25. (canceled)

26. A window shade for a vehicle, comprising:
a shade member;
mounting means for mounting said shade member to a vehicle window; and
a temperature sensor, said temperature sensor being mounted on said window shade so as to be thermally insulated from said vehicle window.

27. A window shade according to claim 26, wherein said temperature sensor is mounted so as to have at least 1 millimeter of good insulating material between said temperature sensor and said vehicle window.

28. A window shade according to claim 27, wherein said good insulating material comprises a plastic material.

29. A window shade for a vehicle according to claim 26, wherein said temperature sensor is made of a thermochromic material.

30. A window shade for a vehicle according to claim 26, further comprising a handle.

31. A window shade for a vehicle according to claim 30, wherein said temperature sensor is located on said handle.

32. A window shade for a vehicle according to claim 30, wherein said temperature sensor is recessed within said handle.

33. A window shade for a vehicle according to claim 30, further comprising a metal bar located proximate to said handle to provide a heat sink in order to thermally insulate said temperature sensor.

34. A window shade for a vehicle according to claim 26, wherein said temperature sensor is located on said shade member.

35. A window shade for a vehicle according to claim 26, wherein said temperature sensor has a temperature display.

36. (canceled)
